(19) United States
(12) Patent Application Publication
(10) Pub. No.: US 2022/0320914 A1
(43) Pub. Date: Oct. 6, 2022

(54) STORAGE CABINET FOR WEARABLE DEVICE, AND USAGE METHOD FOR STORAGE CABINET

(71) Applicants: QINGDAO HAIER WASHING MACHINE CO., LTD., Qingdao, Shandong (CN); HAIER SMART HOME CO., LTD., Qingdao, Shandong (CN)

(72) Inventors: Sheng XU, Qingdao, Shandong (CN); Yang LI, Qingdao, Shandong (CN); Zhenxing HUANG, Qingdao, Shandong (CN); Junming YIN, Qingdao, Shandong (CN)

(73) Assignees: QINGDAO HAIER WASHING MACHINE CO., LTD., Qingdao, Shandong (CN); HAIER SMART HOME CO., LTD., Qingdao, Shandong (CN)

(21) Appl. No.: 17/606,234

(22) PCT Filed: Apr. 13, 2020
(86) PCT No.: PCT/CN2020/084388

§ 371 Date: Oct. 25, 2021

(30) Foreign Application Priority Data
Apr. 24, 2019 (CN) 201910332711.1

(51) Int. Cl. H02J 50/90; H02J 7/00; H02J 50/10; A47B 61/00

(52) U.S. Cl. CPC H02J 50/90; H02J 7/0044; H02J 50/10; A47B 61/00; A47B 2220/0077

(57) ABSTRACT

A storage cabinet comprises a cabinet body having at least one space for accommodating a wearable device. In correspondence to the space, a wireless power supply module is arranged on the cabinet body, the wireless power supply module is used for receiving energy transmitted from outside to the cabinet body and for emitting energy from the cabinet body to outside. The wireless power supply module comprises a wireless power supply receiver and a wireless power supply emitter, with the wireless power supply receiver being used for receiving the energy transmitted from outside to the cabinet body, and the wireless power supply emitter being used for emitting the energy from the cabinet body to outside. With this arrangement, a plurality of independent storage cabinets can be placed and displayed in a certain range according to requirements, thereby meeting the requirements of various situations.

### TECHNICAL FIELD

The disclosure relates to the technical field of electronic device, and particularly herein relates to a storage cabinet for wearable device and a usage method for the storage cabinet.

### BACKGROUND

With the improvement of people's living standards, there are more and more clothes, especially shoes, hats and bags. As a result, storage and placement becomes a problem, and there are more and more nursing needs for these clothes. For example, when shoes are worn, it is necessary to deal with odors like smell of sweat. And mildew and moisture proofing are needed if shoes are not worn for a long time. Also, shoes are expected to be warm before going out in winter. Bags also have care requirements like mildew proofing, moisture proofing and etc. In addition, markets for shoes and hats are expected to have a better display method, such as lighting, so as to be clean and beautiful, and mildew and moisture proofing is also needed. Traditional shoe cabinets or shoe and bag showcases appearing recently are basically made of wood and other plates, without considering of power consumption, especially when the shoe cabinet and shoe box are placed at home, there is often no reserved power socket. However, requirements described above, including “when shoes are worn, it is necessary to deal with odors like smell of sweat; mildew and moisture proofing are needed if shoes are not worn for a long time; shoes are expected to be warm before going out in winter; bags also have care requirements like mildew proofing, moisture proofing and etc.; in addition, markets for shoes and hats are expected to have a better display method, such as lighting”, all need electricity. And the more things are placed, the more power is needed, or they need to connect to each other, resulting to plenty of wires. It will make a mess and can also bring potential risks.

A Chinese patent, with application number CN201620835799.0, discloses a wireless charging device for smart shoes, relating to the technical field of safe smart shoes. The wireless charging device comprises a shoe box and smart shoes, a bottom of the shoe box is provided with a wireless charging base and a wireless charging transmitter, and a side of the shoe box is provided with a USB charging port; a battery and a wireless charging coil is arranged in a sole of the smart shoe, and the wireless charging coil is connected with the battery; when the smart shoes is placed on the shoe box, the wireless charging coil is aligned with the wireless charging transmitter and receives current.

A Chinese patent, with application number CN201620117453.7, discloses a display shoe box, relating to the technical field of electronic device, and the main purpose is to display shoes in the display shoe box so as to achieve better display effect. A main technical scheme of the utility model is: a display shoe box, comprising a base that has a first surface, the first surface comprises a first zone and a second zone around the first zone, the first zone is used for placing shoes, and the second zone is provided with a lighting part; a shoe cover which is made of transparent material, the shoe cover comprises a side wall and a top wall, the side wall surrounds the top wall to form a holding cavity and a first opening connecting with the holding cavity, the shoe cover is detachably connected with the base, and make the first opening cover the first surface of the base.

Although above prior arts give the technical scheme of storing shoes in the shoe box and how to charge the shoe box, the above prior arts cannot solve the problems of inconvenient power supply and multi-group of display wires.

Therefore, it is necessary to make improvements according to shortcomings and defects of the prior arts so as to provide a storage cabinet for wearable device and a usage method for the storage cabinet. The storage cabinet is provided with a wireless power supply receiver and a wireless power supply emitter so as to realize wireless charging of the storage cabinet. And through wireless power supply between cabinet bodies, the storage cabinets can be placed within a certain range according to requirements, thereby meeting the usage requirements of various situations and avoiding mess and potential risks brought by too many wires on the storage cabinet.

In view of this, the disclosure is proposed.

### SUMMARY

The technical problem to be solved by the disclosure is to overcome the disadvantages of the prior art and provide a storage cabinet for wearable device that is capable of overcoming above problems or at least solving part of the above problems.

Another purpose of the disclosure is to provide a usage method of the storage cabinet.

In order to solve the technical problem above, the basic idea of the technical scheme adopted by the disclosure is: a storage cabinet for wearable device comprising:

a cabinet body, in which at least one space for accommodating a wearable device is provided;

in correspondence to the space, a wireless power supply module is arranged on the cabinet body;

the wireless power supply module is used for receiving energy transmitted from outside to the cabinet body and for emitting energy from the cabinet body to outside.

Further, also including

the wireless power supply module comprises a wireless power supply receiver and a wireless power supply emitter;

the wireless power supply receiver is used for receiving the energy transmitted from outside to the cabinet body;

and the wireless power supply emitter is used for emitting the energy from the cabinet body to outside.

Wherein, also including the wireless power supply receiver is capable of identifying designated power supply device, wirelessly connecting with the designated power supply device, and transmitting energy from the designated power supply device to the cabinet body in form of wireless power supply;

in an embodiment, the wireless power supply receiver is capable of identifying the designated power supply device within a certain range so as to realize wireless power supply;

in an embodiment, the certain range is between 0 and 50 cm.

In addition, also including

the wireless power supply emitter is capable of identifying designated power demand device, wirelessly connecting with the designated power demand device, and transmitting energy from the cabinet body to the designated power demand device in form of wireless power supply;

in an embodiment, the wireless power supply emitter is capable of identifying at least one designated power demand device;

in an embodiment, the wireless power supply emitter is capable of identifying the designated power demand device within a certain range so as to realize wireless radiant power supply;

in an embodiment, the certain range is between 0 and 50 cm.

Meanwhile, also including

space inside the cabinet body is able to be observed from at least one side of the cabinet body from outside;

in an embodiment, at least one side of the cabinet body is made of transparent material;

in an embodiment, an energy accumulator, used for storing energy received by the wireless power supply receiver;

in an embodiment, a controller, used for setting working states of the energy accumulator of the cabinet, the wireless power supply receiver and the wireless power supply emitter;

in an embodiment, any one or a combination of several functional units among lighting unit, sterilization unit, ozone unit, plasma unit and fan unit is provided inside the cabinet body.

And, also including

at least two spaces for accommodating wearable device are provided inside the cabinet body;

the cabinet body is capable of being separated into independent cabinet bodies according to number of the spaces.

A usage method for a storage cabinet for wearable device, comprising any one of the storage cabinets for wearable device above, includes following steps,

at least two cabinet bodies are placed adjacent to each other within in an effective power-supply range of the power supply device;

the cabinet body is paired with the power supply device so as to realize wireless power supply of the cabinet body by the power supply device assigned.

Wherein, also including

when the cabinet bodies are within the effective power-supply range of the power supply device, at least one cabinet body is paired with the power supply device, and the cabinet body paired with the power supply device is paired with other cabinet body;

in an embodiment, the cabinet body paired with the power supply device receives energy from the power supply device through the wireless power supply receiver;

and provides wireless power supply for other cabinet body through the wireless power supply emitter.

In addition, also including

when at least one cabinet body is placed within the effective power-supply range of the power supply device and other cabinet body is placed outside the effective power-supply range of the power supply device, the cabinet body within the effective power-supply range of the power supply device is paired with the power supply device, and the cabinet body paired with the power supply device is paired with the cabinet body outside the effective power-supply range of the power supply device;

in an embodiment, the cabinet body within the effective power-supply range of the power supply device receives energy from the power supply device through the wireless power supply receiver;

and provides wireless power supply for the cabinet body outside the effective power-supply range of the power supply device through the wireless power supply emitter.

Meanwhile, also including

when the cabinet bodies are out of the effective power-supply range of the power supply device, the cabinet bodies are paired;

at least one cabinet body is wireless connected with the wireless power supply receiver of other cabinet body through the wireless power supply emitter so as to provide wireless power supply for other cabinet body.

And, also including

the cabinet body is capable of charging the wearable device;

in an embodiment, the wearable device is place inside the cabinet body, or within an effective power-supply range of the wireless power supply emitter of the cabinet body;

in an embodiment, the controller is capable of controlling at least one or several functional units among the lighting unit, the sterilization unit, the ozone unit, the plasma unit and the fan unit;

in an embodiment, the controller is capable of being paired with a remote terminal, and the function of the controller is realized on the remote terminal.

Adopting the technical scheme above, the disclosure has following beneficial effects compared with the prior art:

1. The disclosure provides a storage cabinet with a wireless power supply receiver and a wireless power supply emitter so as to realize wireless charging of the storage cabinet. And through wireless power supply between cabinet bodies, the storage cabinets can be placed within a certain range according to requirements, thereby meeting the usage requirements of various situations and avoiding mess and potential risks brought by too many wires on the storage cabinet.

2. The storage cabinet is provided with the wireless power supply receiver, the wireless power supply emitter and the energy accumulator, so that the storage cabinet itself is capable of being a power supply device. Where there is no power supply or power supply is inconvenient, the storage cabinets are capable of providing power supply between each other so as to realize their function.

3. The wireless power supply receiver and the wireless power supply emitter arranged on the storage cabinet is capable of identifying each other within a certain range, which greatly improves the flexibility of the storage cabinet when being use. When display of products or space is limited, it can make good use of the function of radiant power supply to meet the demand.

The implementation of the disclosure will be described in further detail with reference to the attached figures.

### BRIEF DESCRIPTION OF THE DRAWINGS

As a part of the disclosure, the attached drawings are used to provide a further understanding of the disclosure. The embodiments and descriptions of the disclosure are used to explain the disclosure and is not to be considered as improper limitation of the disclosure. Obviously, the following drawings are only some embodiments. For the person skilled in the art, other drawings can be obtained according to these drawings without any creative work.

In the attached drawings:

FIG. 1 is a first diagram of a storage cabinet for wearable device of the disclosure;

FIG. 2 is a second diagram of a storage cabinet for wearable device of the disclosure;

FIG. 3 is a first diagram of a control logic of the storage cabinet for wearable device of the disclosure;

FIG. 4 is a second diagram of a control logic of the storage cabinet for wearable device of the disclosure;

FIG. 5 is a third diagram of a control logic of the storage cabinet for wearable device of the disclosure.

In the drawings: 1, cabinet body; 2, wireless power supply receiver; 3, wireless power supply emitter; 4, power supply device; 5, power demand device; 6, energy accumulator; 7, controller.

It should be noted that these drawings and descriptions are not to limit the conception of the disclosure in any way, but to illustrate the concept of the disclosure for the person skilled in the art by referring to specific embodiments.

### DETAILED DESCRIPTION

The technical scheme in the following embodiments will then be described clearly and completely with combination with the attached figures in order to make the purpose, technical scheme and advantages of the disclosure clearer. The following embodiments are used to illustrate the disclosure but are not used to limit the scope of the disclosure.

In the following description, it should be noted that the terms “up”, “down”, “front”, “back”, “left”, “right”, “vertical”, “inside”, “outside” and etc. are based on the directions or positions shown in the attached figures. They are used to simplify the description, rather than to indicate that the device or element referred must have a specific direction or to be constructed or operated in a specific direction.

And in the following description, it should be understood that the terms “installment” and “connection” should be treated according to generalized understanding. For example, they can be understood as fixed connection, detachable connection or integrated connection. Also, they can mean mechanical connection or electrical connection. They can also represent direct connection or indirect connection. The person skilled in the art are able to understand the specific meaning of the above terms in the disclosure according to the specific situation.

In order to meet the requirement of facilitating the storage of wearable devices like shoes and hats and the display of them in different scenes, the disclosure develops following technical scheme.

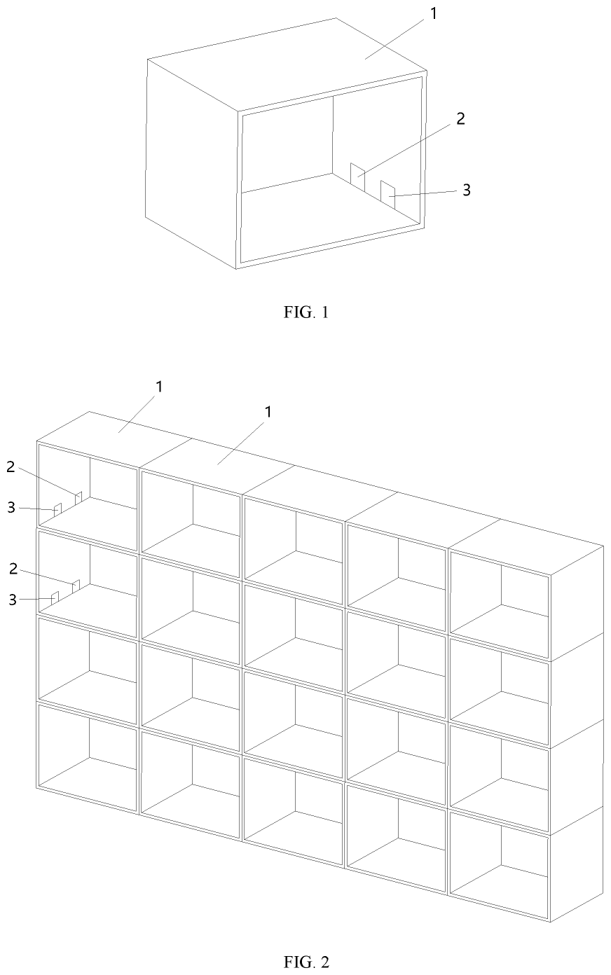

FIG. 1 and FIG. 2 is a first and second diagram of a storage cabinet for wearable device of the disclosure. It can be seen from the figures that the storage cabinet for wearable device comprises a cabinet body 1, a wireless power supply receiver 2 and a wireless power supply emitter 3, and the wireless power supply receiver 2 is paired with a power supply device 4 so as to realize wireless power supply. The wireless power supply has a certain effect of radiant power supply, that is, within a certain range, the wireless power supply receiver 2 is paired with the power supply device 4, so that the power supply device 4 is capable of providing power supply to the cabinet body 1 through the wireless power supply receiver 2, avoiding the problem that connecting wires is required for conventional charging. The cabinet body 1 itself is provided with the wireless power supply emitter 3, the wireless power supply emitter 3 is paired with the wireless power supply receiver 2 of other cabinet body 1 or with power demand device 5 so as to realize wireless power supply from the cabinet body 1 to other cabinet body 1 or power demand device 5. In practical application, due to the limitation of home environment space, there are no corresponding power sockets in some place, or due to the limitation of product display site, display method and placement method, placement shape and position of the storage cabinet need to be changed frequently. The wireless powered storage cabinet for wearable device of the disclosure well adapts the above situation, avoiding the problem of bad display effect and potential safety hazards caused by the cabinet body 1 like conventional display cabinet which needs to be connected with the power line to charge. In addition, the cabinet body 1 is also provided with an energy accumulator 6, a controller 7, some functional units and etc. When the cabinet body 1 is being charged by the power supply device, the energy accumulator 6 stores excess electric energy. And when the cabinet body 1 is out of an effective power-supply range of the power supply device 4 and still needs to be displayed or used, the electric energy stored in the energy accumulator can be used so as to realize application of wireless power supply under various occasions and environments. And various functional units meet the requirement of the storage of wearable device like shoes and hats, and also provide corresponding care for wearable device. For example, when shoes are worn, it is necessary to deal with odors like smell of sweat. And mildew and moisture proofing are needed if shoes are not worn for a long time. Also, shoes are expected to be warm before going out in winter. Bags also have care requirements like mildew proofing, moisture proofing and etc. In addition, markets for shoes and hats are expected to have a better display method, such as lighting, so as to be clean and beautiful, and mildew and moisture proofing is also needed.

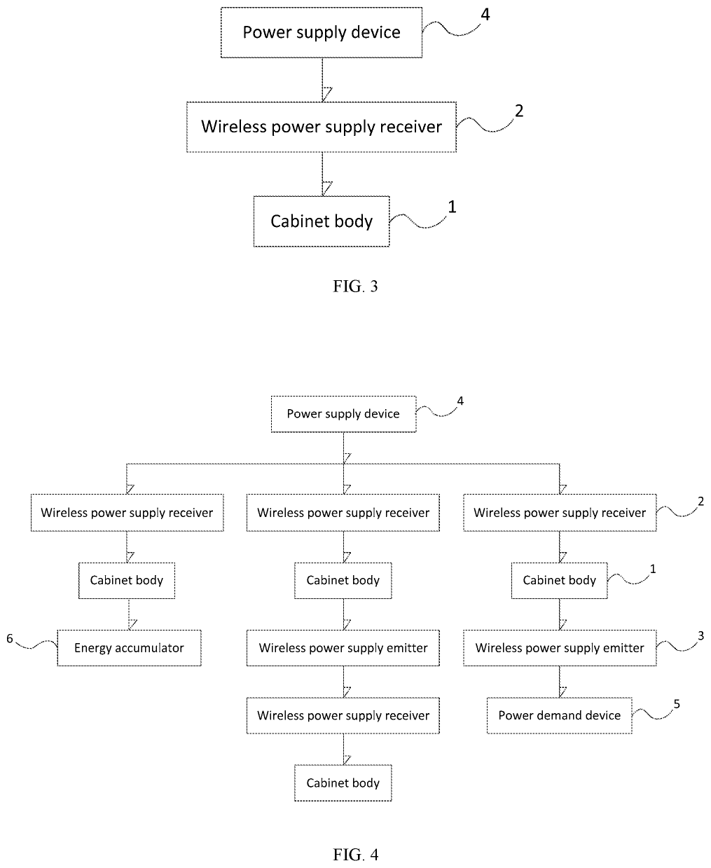

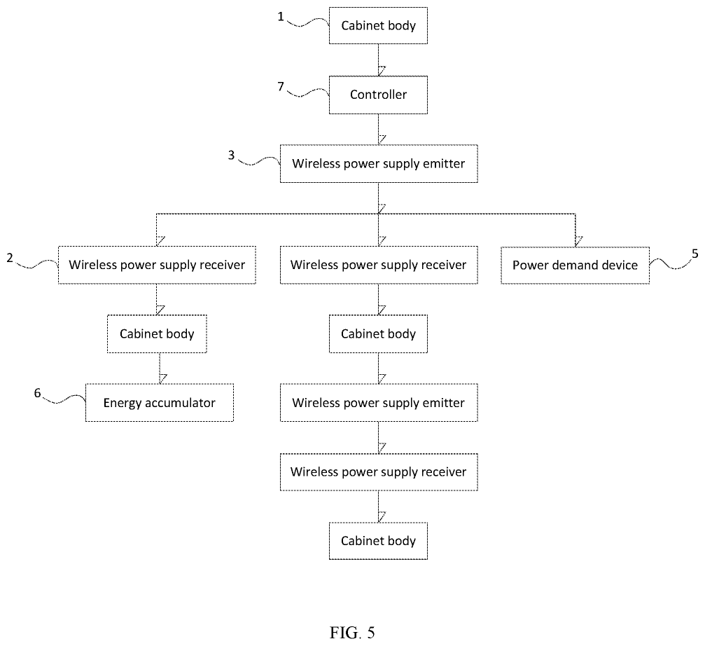

FIG. 3, FIG. 4 and FIG. 5 is a first, second and third diagram of a control logic of the storage cabinet for wearable device of the disclosure. It can be seen from the figures that several usage methods for the storage cabinet for wearable device are respectively shown in FIG. 3, FIG. 4 and FIG. 5. For example, the cabinets bodies 1 are inside the effective power-supply range of the power supply device 4; some of the cabinet bodies 1 are inside the effective power-supply range of the power supply device 4, and other cabinet bodies 1 are outside the effective power-supply range of the power supply device 4; all of the cabinet bodies 1 are outside the effective power-supply range of the power supply device 4, etc. Through the display of various application environments and situations, the usage mode and method of the storage cabinet for wearable device of the disclosure are fully displayed.

In the disclosure, the storage cabinet is provided with the wireless power supply receiver 2 and the wireless power supply emitter 3 so as to realize wireless charging of the storage cabinet. And through wireless power supply between cabinet bodies 1, the storage cabinets can be placed within a certain range according to requirements, thereby meeting the usage requirements of various situations and avoiding mess and potential risks brought by too many wires on the storage cabinet. The storage cabinet is provided with the wireless power supply receiver 2, the wireless power supply emitter 3 and the energy accumulator 6, so that the storage cabinet itself is capable of being a power supply device 4. Where there is no power supply or power supply is inconvenient, the storage cabinets are capable of providing power supply between each other so as to realize their function. The wireless power supply receiver 2 and the wireless power supply emitter 3 arranged on the storage cabinet is capable of identifying each other within a certain range, which greatly improves the flexibility of the storage cabinet when being use. When display of products or space is limited, it can make good use of the function of radiant power supply to meet the demand.

### Embodiment 1

As shown in FIG. 1 and FIG. 2, a storage cabinet for wearable device of the embodiment comprises a cabinet body, in which at least a space for accommodating a wearable device is provided. In correspondence to the space, a wireless power supply receiver 2 and a wireless power supply emitter 3 is arranged on the cabinet body 1. The wireless power supply receiver 2 is used for receiving the energy transmitted from outside to the cabinet body 1, and the wireless power supply emitter 3 is used for emitting the energy from the cabinet body 1 to outside. The energy described in the embodiment can be understood as electric energy.

Further, the wireless power supply receiver 2 is capable of identifying designated power supply device 4, wirelessly connecting with the designated power supply device 4, and transmitting energy from the designated power supply device 4 to the cabinet body 1 in form of wireless power supply.

More further, the wireless power supply emitter 3 is capable of identifying designated power demand device 5, wirelessly connecting with the designated power demand device 5, and transmitting energy from the cabinet body 1 to the designated power demand device 5 in form of wireless power supply.

FIG. 1 and FIG. 2 is a first and second diagram of the storage cabinet for wearable device of the disclosure. It can be seen from the figures that the storage cabinet for wearable device comprises a cabinet body 1, a wireless power supply receiver 2 and a wireless power supply emitter 3, and the wireless power supply receiver 2 is paired with a power supply device 4 so as to realize wireless power supply. The wireless power supply has a certain effect of radiant power supply, that is, within a certain range, the wireless power supply receiver 2 is paired with the power supply device 4, so that the power supply device 4 is capable of providing power supply to the cabinet body 1 through the wireless power supply receiver 2, avoiding the problem that connecting wires is required for conventional charging. The cabinet body 1 itself is provided with the wireless power supply emitter 3, the wireless power supply emitter 3 is paired with the wireless power supply receiver 2 of other cabinet body 1 or with power demand device 5 so as to realize wireless power supply from the cabinet body 1 to other cabinet body 1 or power demand device 5.

### Embodiment 2

As shown in FIG. 1 to FIG. 5, the embodiment is a further description of the above embodiment 1. In the storage cabinet for wearable device of the embodiment, the wireless power supply receiver 2 is capable of identifying the designated power supply device 4 within a certain range so as to realize wireless power supply, and the wireless power supply emitter 3 is capable of identifying the designated power demand device 5 within a certain range so as to realize wireless radiant power supply. The certain range is between 0 and 50 cm.

Among the figures, FIG. 1 and FIG. 2 is a first and second diagram of the storage cabinet for wearable device of the disclosure. In practical application, due to the limitation of home environment space, there are no corresponding power sockets in some place, or due to the limitation of product display site, display method and placement method, placement shape and position of the storage cabinet need to be changed frequently. The wireless powered storage cabinet for wearable device of the disclosure well adapts the above situation, avoiding the problem of bad display effect and potential safety hazards caused by the cabinet body 1 like conventional display cabinet which needs to be connected with the power line to charge.

### Embodiment 3

As shown in FIG. 1 to FIG. 5, the embodiment is a further description of the above embodiment 1 or 2. In the storage cabinet for wearable device of the embodiment, space inside the cabinet body 1 is able to be observed from at least one side of the cabinet body 1 from outside. Further, at least one side of the cabinet body 1 is made of transparent material. In the display of wearable products, it is usually arranged that at least one direction has transparent effect, and the embodiment meets the above requirement well. When using the cabinet body 1, the side from which space inside the cabinet body 1 is able to be observed is placed facing to a display direction according to requirement.

### Embodiment 4

As shown in FIG. 1 to FIG. 5, the embodiment is a further description of any one of the above embodiment 1 to 3. In the embodiment, the storage cabinet also includes an energy accumulator 6, for storing energy received by the wireless power supply receiver 2. Further, the storage cabinet also includes a controller 7, used for setting working states of the energy accumulator 6 of the cabinet, the wireless power supply receiver 2 and the wireless power supply emitter 3. More further, any one or a combination of several functional units among lighting unit, sterilization unit, ozone unit, plasma unit and fan unit is provided inside the cabinet body 1. FIG. 1 and FIG. 2 is a first and second diagram of the storage cabinet for wearable device of the disclosure. The cabinet body 1 is also provided with an energy accumulator 6, a controller 7, some functional units and etc. When the cabinet body 1 is being charged by the power supply device 4, the energy accumulator 6 stores excess electric energy. And when the cabinet body 1 is out of an effective power-supply range of the power supply device 4 and still needs to be displayed or used, the electric energy stored in the energy accumulator 6 can be used so as to realize application of wireless power supply under various occasions and environments. And various functional units meet the requirement of the storage of wearable device like shoes and hats, and also provide corresponding care for wearable device. For example, when shoes are worn, it is necessary to deal with odors like smell of sweat. And mildew and moisture proofing are needed if shoes are not worn for a long time. Also, shoes are expected to be warm before going out in winter. Bags also have care requirements like mildew proofing, moisture proofing and etc. In addition, markets for shoes and hats are expected to have a better display method, such as lighting, so as to be clean and beautiful, and mildew and moisture proofing is also needed.

### Embodiment 5

As shown in FIG. 2, the embodiment is a further description of any one of the above embodiment 1 to 4. In the storage cabinet for wearable device of the embodiment, at least two spaces for accommodating wearable device are provided inside the cabinet body 1, and the cabinet body 1 is capable of being separated into independent cabinet bodies 1 according to number of the spaces. Specifically, as shown in FIG. 2, at least two independent cabinet bodies 1 form the storage cabinet for wearable device, each cabinet body 1 is provided with the wireless power supply receiver 2 and the wireless power supply emitter 3, and each cabinet body 1 is able to be placed separately. According to actual display requirement, the cabinet bodies 1 are placed at different position to display, the cabinet bodies 1 is paired with others through the wireless power supply receiver 2 and the wireless power supply emitter 3 so as to realize wireless power supply between each other. Otherwise, within the effective power-supply range of the power supply device 4, the wireless power supply receiver 2 is paired with the power supply device 4 so as to realize wireless power supply.

### Embodiment 6

The embodiment is a further description of any one of the above embodiment 1 to 5. The storage cabinet for wearable device of the embodiment is used for storing smart shoes.

### Embodiment 7

As shown in FIG. 3 and FIG. 4, the embodiment provides a usage method for the storage cabinet for wearable device described in any one of the above embodiment 1 to 6. The usage method includes following steps: at least two cabinet bodies 1 are placed adjacent to each other within in the effective power-supply range of the power supply device 4; the cabinet body 1 is paired with the power supply device 4 so as to realize wireless power supply of the cabinet body 1 by the power supply device 4 assigned.

### Embodiment 8

As shown in FIG. 3 and FIG. 4, the embodiment is a further description of the above embodiment 7. In the usage method for the storage cabinet for wearable device of the embodiment, when the cabinet bodies 1 are within the effective power-supply range of the power supply device 4, at least one cabinet body 1 is paired with the power supply device 4, and the cabinet body 1 paired with the power supply device 4 is paired with other cabinet body 1. The cabinet body 1 paired with the power supply device 4 receives energy from the power supply device 4 through the wireless power supply receiver 2 and provides wireless power supply for other cabinet body 1 through the wireless power supply emitter 3.

### Embodiment 9

As shown in FIG. 3 and FIG. 4, the embodiment is a further description of the above embodiment 7 or 8. In the usage method for the storage cabinet for wearable device of the embodiment, when at least one cabinet body 1 is placed within the effective power-supply range of the power supply device 4 and other cabinet body 1 is placed outside the effective power-supply range of the power supply device 4, the cabinet body 1 within the effective power-supply range of the power supply device 4 is paired with the power supply device 4, and the cabinet body 1 paired with the power supply device 4 is paired with the cabinet body 1 outside the effective power-supply range of the power supply device 4. The cabinet body 1 within the effective power-supply range of the power supply device 4 receives energy from the power supply device 4 through the wireless power supply receiver 2 and provides wireless power supply for the cabinet body 1 outside the effective power-supply range of the power supply device 4 through the wireless power supply emitter 3.

### Embodiment 10

As shown in FIG. 3 and FIG. 4, the embodiment is a further description of any one of the above embodiment 7 to 9. In the usage method for the storage cabinet for wearable device of the embodiment, when the cabinet bodies 1 are out of the effective power-supply range of the power supply device 4, the cabinet bodies 1 are paired. At least one cabinet body 1 is wireless connected with the wireless power supply receiver 2 of other cabinet body through the wireless power supply emitter 3 so as to provide wireless power supply for other cabinet body 1.

### Embodiment 11

As shown in FIG. 3 and FIG. 4, the embodiment is a further description of any one of the above embodiment 7 to 10. In the usage method for the storage cabinet for wearable device of the embodiment, the cabinet body 1 is capable of charging the wearable device. The wearable device is place inside the cabinet body 1, or within the effective power-supply range of the wireless power supply emitter 3 of the cabinet body 1. The controller 7 is capable of being paired with a remote terminal, and the function of the controller 7 is realized on the remote terminal.

### Embodiment 12

As shown in FIG. 3 and FIG. 4, the embodiment is a further description of any one of the above embodiment 7 to 11. In the usage method for the storage cabinet for wearable device of the embodiment, the controller 7 is capable of controlling at least one or several functional units among the lighting unit, the sterilization unit, the ozone unit, the plasma unit and the fan unit. Various functional units meet the requirement of the storage of wearable device like shoes and hats, and also provide corresponding care for wearable device. For example, when shoes are worn, it is necessary to deal with odors like smell of sweat. And mildew and moisture proofing are needed if shoes are not worn for a long time. Also, shoes are expected to be warm before going out in winter. Bags also have care requirements like mildew proofing, moisture proofing and etc. In addition, markets for shoes and hats are expected to have a better display method, such as lighting, so as to be clean and beautiful, and mildew and moisture proofing is also needed.

A large number of specific details are described in the description herein. However, it should be understood that the embodiments of the disclosure are able to be practiced without these specific details. In some embodiments, well-known methods, structures and techniques are not shown in detail so as not to obscure the understanding of the description.

Similarly, it should be understood that in order to simplify the disclosure and to help understand one or more of various aspects of the disclosure, in the above description of the exemplary embodiments of the disclosure, various features of the disclosure are sometimes grouped into a single embodiment, figure, or description thereof. However, the disclosed method should not be interpreted to reflect following intention: the claimed disclosure requires more features than the features explicitly recorded in each claim. More precisely, as reflected in following claims, the aspect of the disclosure is less than all the features of a single embodiment disclosed above. Therefore, the claims following the specific embodiment are hereby expressly incorporated into the specific embodiment, wherein each claim itself is a separate embodiment of the disclosure.

In addition, any person skilled in the art should understand that though some embodiments described herein include some features contained in other embodiments rather than other features, the combination of features in different embodiments also means that they are within the protection range of the disclosure and form different embodiments. For example, any person skilled in the art should be able to use the above embodiments combined with each other according to the known technical scheme and the technical problem to be solved in the disclosure.

The above description is just used to illustrate some more practical embodiments of the disclosure but is not the limitation of the disclosure in any way. Although the disclosure has been enclosed as the above embodiments, they are not used to limit the disclosure. Within the technical scheme of the disclosure, any person skilled in the art should be able to make some changes or modifications based on the above techniques to obtain other embodiments with equal benefits. But any simple changes, equivalent changes or modifications, made to the above embodiments according to the technical substance within the technical scheme of the disclosure, still belong to the protection range of the disclosure.

1. A storage cabinet for a wearable device comprising:
a cabinet body, in which a space for accommodating the wearable device is provided;
a wireless power supply module being arranged on the cabinet body in correspondence to the space; wherein,
the wireless power supply module is used for receiving energy transmitted from outside to the cabinet body and for emitting energy from the cabinet body to outside.

2. The storage cabinet for the wearable device according to claim 1, wherein,
the wireless power supply module comprises a wireless power supply receiver, and a wireless power supply emitter;
the wireless power supply receiver is used for receiving energy transmitted from outside to the cabinet body;
and the wireless power supply emitter is used for emitting energy from the cabinet body to outside.

3. The storage cabinet for a wearable device according to claim 2, wherein,
the wireless power supply receiver is capable of identifying a designated power supply device, wirelessly connecting with the designated power supply device, and transmitting energy from the designated power supply device to the cabinet body in the form of a wireless power supply.

4. The storage cabinet for the wearable device according to claim 2, wherein,
the wireless power supply emitter is capable of identifying a designated power demand device, wirelessly connecting with the designated power demand device, and transmitting energy from the cabinet body to the designated power demand device in the form of a wireless power supply.

5. The storage cabinet for a wearable device according to claim 1, wherein,
the space inside the cabinet body is able to be observed from at least one side of the cabinet body from outside;
at least one side of the cabinet body is made of transparent material; and
any one or a combination of several functional units among a lighting unit, a sterilization unit, an ozone unit, a plasma unit and a fan unit is provided inside the cabinet body.

6. A usage method for a storage cabinet for a wearable device, comprising the storage cabinet for the wearable device according to claim 3, comprising the following steps,
at least two cabinet bodies are placed adjacent to each other within in an effective power-supply range of the power supply device;
the cabinet body is paired with the power supply device so as to realize wireless power supply of the cabinet body by the designated power supply device.

7. The usage method for the storage cabinet for the wearable device according to claim 6, wherein,
when the cabinet bodies are within the effective power-supply range of the power supply device, at least one cabinet body is paired with the power supply device, and the cabinet body paired with the power supply device is paired with another cabinet body.

8. The usage method for the storage cabinet for the wearable device according to claim 6, wherein,
when at least one cabinet body is placed within the effective power-supply range of the power supply device and another cabinet body is placed outside the effective power-supply range of the power supply device, the cabinet body within the effective power-supply range of the power supply device is paired with the power supply device, and the cabinet body paired with the power supply device is paired with the cabinet body outside the effective power-supply range of the power supply device.

9. The usage method for the storage cabinet for the wearable device according to claim 6, wherein,
when plural cabinet bodies are out of the effective power-supply range of the power supply device, the cabinet bodies are paired between each other;
at least one cabinet body is wirelessly connected with the wireless power supply receiver of other cabinet body through the wireless power supply emitter so as to provide wireless power supply for other cabinet body.

10. The usage method for the storage cabinet for the wearable device according to claim 6, wherein,
at least one cabinet body is capable of charging the wearable device.

11. The storage cabinet for a wearable device according to claim 3, wherein,
the wireless power supply receiver is capable of identifying the designated power supply device within a certain range so as to realize wireless power supply, and the certain range is between 0 and 50 cm.

12. The storage cabinet for the wearable device according to claim 4, wherein, the wireless power supply emitter is capable of identifying at least one designated power demand device.

13. The storage cabinet for the wearable device according to claim 4, wherein,
the wireless power supply emitter is capable of identifying the designated power demand device within a certain range so as to realize wireless radiant power supply, and the certain range is between 0 and 50 cm.

14. The storage cabinet for a wearable device according to claim 5, wherein,
an energy accumulator, used for storing energy received by the wireless power supply receiver, is provided;
a controller is provided for setting working states of the energy accumulator of the cabinet, the wireless power supply receiver and the wireless power supply emitter.

15. The storage cabinet for a wearable device according to claim 5, wherein,
at least two spaces for accommodating the wearable device are provided inside the cabinet body;
the cabinet body is capable of being separated into independent cabinet bodies according to number of the spaces.

16. The usage method for the storage cabinet for the wearable device according to claim 7, wherein,
the cabinet body paired with the power supply device receives energy from the power supply device through the wireless power supply receiver;
and provides wireless power supply for other cabinet body through the wireless power supply emitter.

17. The usage method for the storage cabinet for the wearable device according to claim 8, wherein,
the cabinet body within the effective power-supply range of the power supply device receives energy from the power supply device through the wireless power supply receiver, and provides wireless power supply for the cabinet body outside the effective power-supply range of the power supply device through the wireless power supply emitter.

18. The usage method for the storage cabinet for the wearable device according to claim 10, wherein the wearable device is place inside the cabinet body, or within the effective power-supply range of the wireless power supply emitter of the cabinet body.

19. The usage method for the storage cabinet for the wearable device according to claim 10, wherein the controller is capable of controlling at least one or several functional units among the lighting unit, the sterilization unit, the ozone unit, the plasma unit and the fan unit.

20. The usage method for the storage cabinet for the wearable device according to claim 10, wherein the controller is capable of being paired with a remote terminal, and the function of the controller is realized on the remote terminal.
